(19) United States
(12) Patent Application Publication
(10) Pub. No.: US 2002/0008378 A1
(43) Pub. Date: Jan. 24, 2002

(54) POCKET INSERT FOR BOUND BOOK

(75) Inventor: MARY SMITH, CALEDONIA, NY (US)

Correspondence Address: Stephen B. Salai, Esq., Harter Secrest and Emery LLP, 1600 Bausch & Lomb Place, Rochester, NY, 14604-2711, US

(73) Assignee: Monroe Graphics,Inc.

(21) Appl. No.: 09/391,869

(22) Filed: Sep. 8, 1999

(51) Int. Cl. B42D 3/00

(52) U.S. Cl. 281/31; 281/29; 281/38

(57) ABSTRACT

A pocket insert for a book includes at least one pocket to receive and retain supplemental media such as a diskette. The pocket insert is bound with pages of the book along an edge that faces openings of the pocket.

### FIELD OF THE INVENTION

This invention relates to a pocket insert for a bound book, especially an electronic media insert. The insert includes at least one pocket adapted to receive and retain supplemental material that cannot easily be bound directly to the book binding, for example, a diskette or CD-ROM.

### BACKGROUND OF THE INVENTION

It is often desired to provide supplemental media along with a book that may be separated easily from the book by a user. For example, in the case of textbooks or other books containing instructional or reference material, a diskette with software thereon relating to the subject matter of the book may be packaged with the book in a manner that the diskette is easily removable from the book so that a user may access the diskette. It may also be desired to provide along with the book supplemental media such as brochures, charts, etc., that may be stored with the book but are not bound to the book so they can be separated easily from the book.

A known commercial method of providing a diskette with a book involves binding a sleeve illustrated in Figure la along with the pages and covers of the book. More specifically, the pages, covers and sleeve 100 are assembled in a stacked arrangement, where sleeve 100 is positioned in the stacked arrangement with flap 101 in a closed, folded-down position (i.e., flap 101 is folded along fold line 102), so that edge 103 is aligned with edges of the pages and covers. Then, edge 103 and the edges of the pages and covers are bound with a common spiral binding through holes 104. Flap 101 is lifted open by an operator, to appear as illustrated in Figure 1b, and a diskette is inserted into the sleeve 100 by an operator. A drawback of this method is that it requires manually assembling the sleeve with respect to the pages and the covers, opening the flap and inserting the diskette. Additionally, unless the book is sealed with a material such as shrink-wrap plastic, there is a possibility for the diskette to fall from the sleeve if the book is inverted during handling.

### SUMMARY OF THE INVENTION

This invention provides a pocket insert for binding in a book along with pages of the book. The pocket insert may be easily assembled with the book pages prior to the binding operation. Additionally, the construction of the pocket insert reduces the risk of media material stored in the pocket insert, such as a diskette, from inadvertently falling from the pocket insert and becoming displaced.

According to a first embodiment, the pocket insert comprises a base sheet of paper material comprising a binding edge bound to the binding, and a pocket sheet of paper material, the perimeter of which is defined by an attached edge section and a free section. The attached edge section is attached to the base sheet and the free edge section is unattached to the base sheet to form a pocket opening along the free edge section. The base and pocket sheets are arranged such that the pocket opens towards the binding.

Additionally, the invention provides a book where the pages and the pocket insert are bound along a common binding. The book may include front and/or back covers bound to the pages and pocket insert, and a media such as a diskette in the pocket of the insert.

According to other embodiments, the pocket insert is defined by a generally rectangular base sheet of paper material and a generally rectangular pocket sheet of paper material, where the base sheet comprises a first edge, a second edge opposed to the first edge for binding to a binder, the first and second edges defining a width of the first sheet, and third and fourth edges opposed to one another and disposed between the first and second edges, the third and fourth edges defining a length of the first sheet. The pocket sheet comprises a first edge attached to the base sheet, a second edge opposed to the first edge, the first and second edges defining a width of the pocket sheet, at least a portion of the second edge being unattached to the base sheet for forming a pocket opening, third and fourth edges opposed to one another and disposed between the first and second edges, the third and fourth edges defining a length of the pocket sheet and being attached to the base sheet, and wherein the second sheet has a shorter width than the first sheet.

According to various preferred embodiment, the pocket sheet has a width at least half the width of the base sheet, more preferably at least 60 percent of the width of the base sheet. The base sheet and the pocket sheet may be formed of separate sheets of paper material that are adhered to one another, for example, along their edges, or that may be formed of a single sheet of paper material with a fold line defining one of the edges of the sheets. The pocket insert may include two pockets formed by the base sheet and the pocket sheet, with both pockets opening towards the base sheet first edge. The base sheet may be formed of a rectangular sheet of paper having a length of about 11 inches and a width of 8 to 8.5 inches, to approximate standard 8.5×11 inch paper, with the pocket sheet formed of rectangular sheet of paper having a length of about 11 inches and a width of 5 to 6 inches.

Additionally, the invention provides a method of binding a book comprising: assembling in a stacked arrangement multiple pages and the pocket insert; and binding the pages and the pocket insert, wherein the pocket insert is bound along its binding edge and the base and pocket sheets are arranged such that the pocket opens towards the binding.

### BRIEF DESCRIPTION OF THE DRAWINGS

FIGS. 1a and 1b are front plan views of a prior sleeve for a diskette that may be bound with book pages.

FIG. 2 is a front plan view of a first embodiment of a pocket insert of this invention.

FIGS. 3-6 are front plan views of additional embodiments of a pocket insert.

FIG. 7 is a perspective, exploded view of a pocket insert arranged in a book.

FIG. 8 is a perspective view of a conventional wire-o binding.

### DETAILED DESCRIPTION OF THE PREFERRED EMBODIMENT

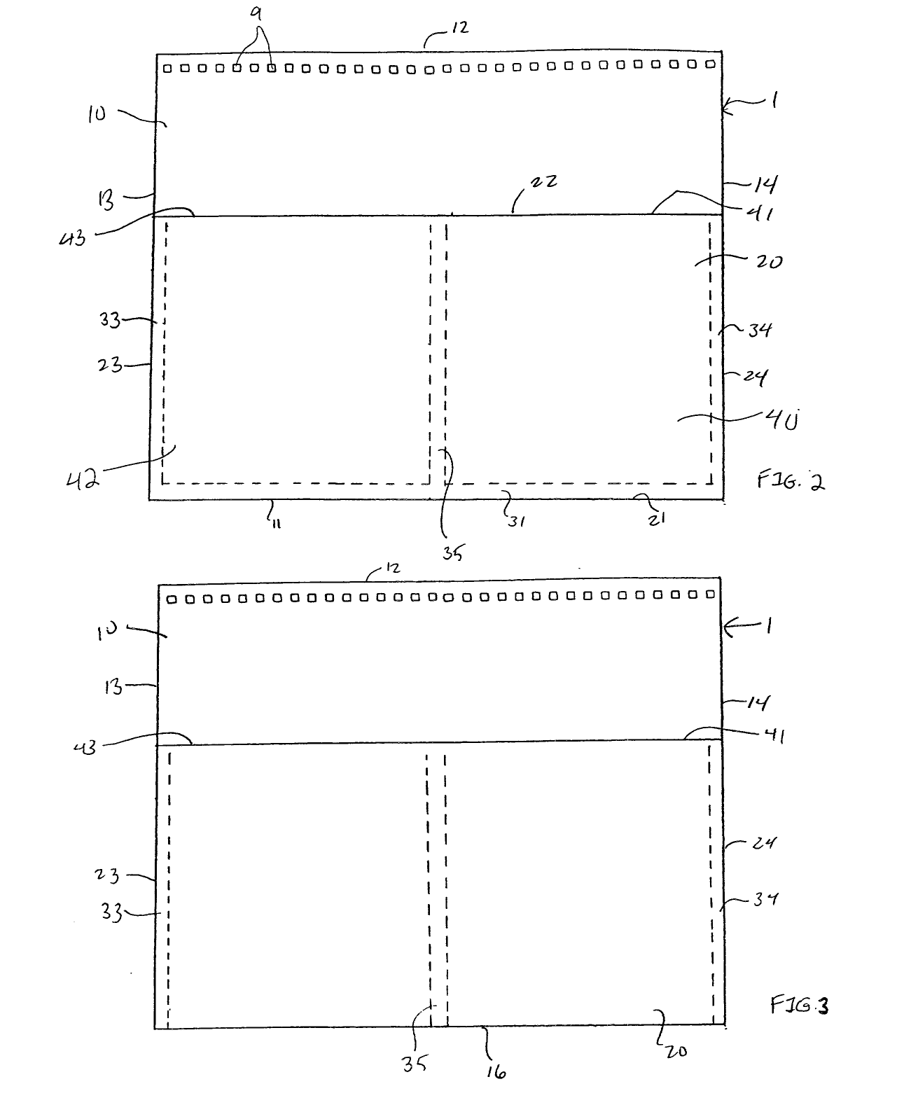

FIG. 2 illustrates a first embodiment of this invention. pocket insert 1 includes base sheet 10 of paper material and pocket sheet 20 of paper material. For this illustrated embodiment, each of the base sheet and the pocket sheet are formed of separate rectangular sheets of paper. Base sheet 10 includes a first edge 11, a second edge 12, a third edge 13 and a fourth edge 14. Second edge 12 is adjacent to the portion of base sheet 10 that will ultimately be bound to a binding. First edge 11 and second edge 12 define the width of the base sheet 10 and third edge 13 and fourth edge 14 define a length of base sheet 10. Pocket sheet 20 includes a first edge 21, a second edge 22, a third edge 23 and a fourth edge 24. First edge 11 is contiguous with first edge 21, third edge 13 is contiguous with third edge 23, and fourth edge 14 is contiguous with fourth edge 24. Additionally, the two sheets are adhered to one another with strips of adhesive. More specifically, adhesive strip 31 is proximate to and along edges 11 and 21, adhesive strip 33 is proximate to and along edges 13 and 23 and adhesive strip 34 is proximate to and along edges 14 and 24.

A suitable class of adhesives is water-based adhesives, such as those available from Knight Adhesive under product nos. 10295 and 10325.

Accordingly, the perimeter of pocket sheet 20 is defined by an attached edge section, which for the illustrated embodiment includes edges 21, 23 and 24. The pocket sheet 20 also includes an unattached edge section, which for the illustrated embodiment is defined by edge 22, at least a portion of which is unattached to the base sheet 10. The attached edge section and unattached edge section form a pocket 40 with a pocket opening 41 that faces the binding portion at edge 12.

The embodiment in FIG. 2 further includes an adhesive strip 35 running widthwise to the two sheets and adhering the sheets together. Strip 35 extends between and parallel to edges 23 and 24 of pocket sheet 20, preferably about midway between these two edges. Accordingly, strip 35 separates pocket 40 from a second pocket 42, pocket 42 having a pocket opening 43. Both openings 41 and 43 face and are parallel to the binding section of base sheet 10 at edge 12.

Pockets 40 and 42 are sized and shaped to receive a diskette, such as a standard 4″ diskette (such diskettes typically being about 3½×3¼ inches). Pocket sheet 20 has a width smaller than base sheet 12, however, it is preferred that pocket sheet 20 has a width that is at least half the width of base sheet 10, more preferably, at least 60% of the width of the base sheet. This ensures that, when pocket insert 1 as in a book, a diskette held in pocket 40 or 42 cannot easily become dislodged from the pocket when the book is handled. In other words, the binding at holes 9 prevents the diskette from fully slipping out of pocket 40.

According to a preferred embodiment of the invention, base sheet 10 is formed of a rectangular sheet of paper having a length of about 11 inches and a width of 8 to 8½ inches, and pocket sheet 20 is formed of a rectangular sheet of paper having a length of about 11 inches and a width of 5 to 6 inches, when the pocket insert is assembled with book pages having a standard size of about 11″×8.5″,

Referring again to FIG. 2, it is possible to omit adhesive strip 35 whereby the pocket insert 1 has a single pocket. The pocket can still be used to retain a diskette, but the larger sized pocket can also receive additional supplemental material, such as a brochure, that would not fit easily in pocket 42.

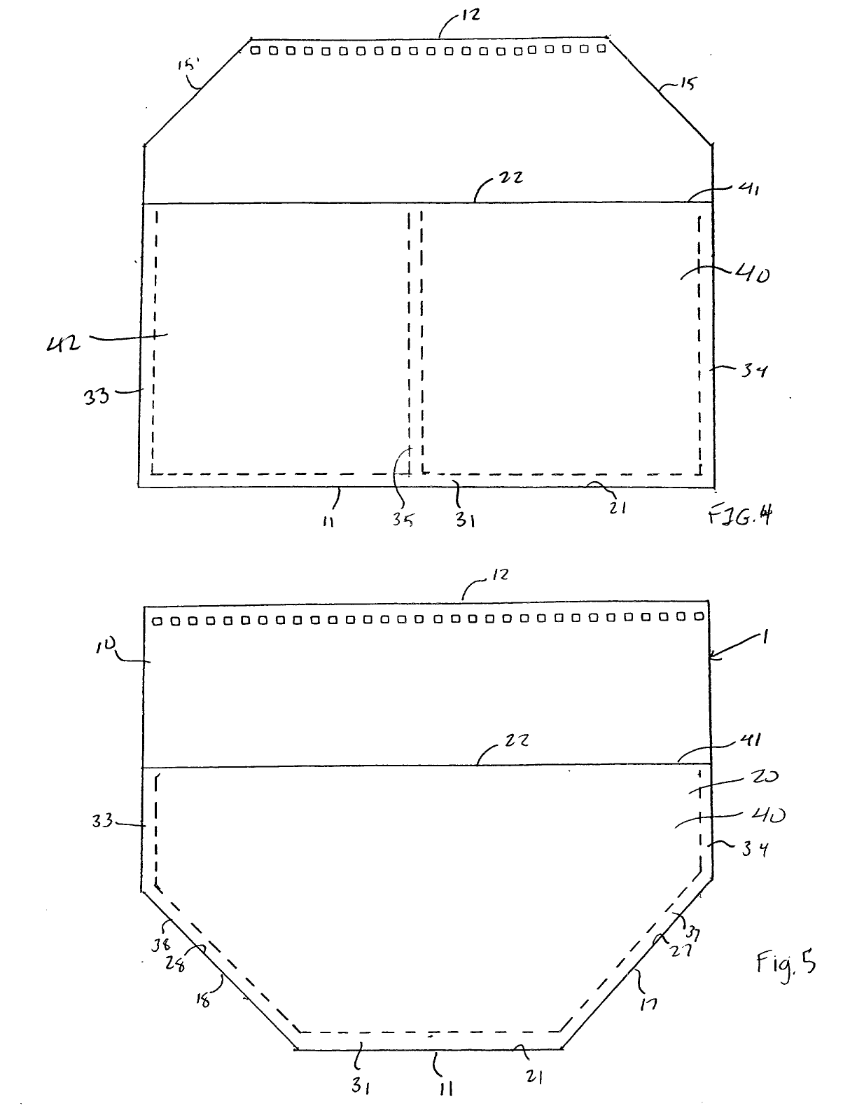

FIG. 3 illustrates an alternate embodiment of a pocket insert 1, where the base sheet 10 and the pocket sheet 20 are formed of a single sheet of paper folded along fold line 16. These two sheets are adhered to one another by adhesive strips 33 and 34 and, optionally adhesive strip 35. Accordingly, fold line 16 defines edges 11 and 21 of the base sheet and pocket sheet, respectively.

FIGS. 4 and 5 illustrate additional embodiments of the invention. FIG. 4 illustrates that it is not necessary for base sheet 12 to be rectangular, as base sheet 10 further includes edges 15 and 15′. FIG. 5 illustrates that is unnecessary for the pocket sheet 22 and the base sheet 10 to be rectangular. In this embodiment, base sheet 10 further includes edge section 17 and 18, and pocket sheet 20 further includes corresponding edges 27 and 37. These edges form part of the attached edge section of the pocket sheet attached to the base sheet through adhesive strip 37 and 38.

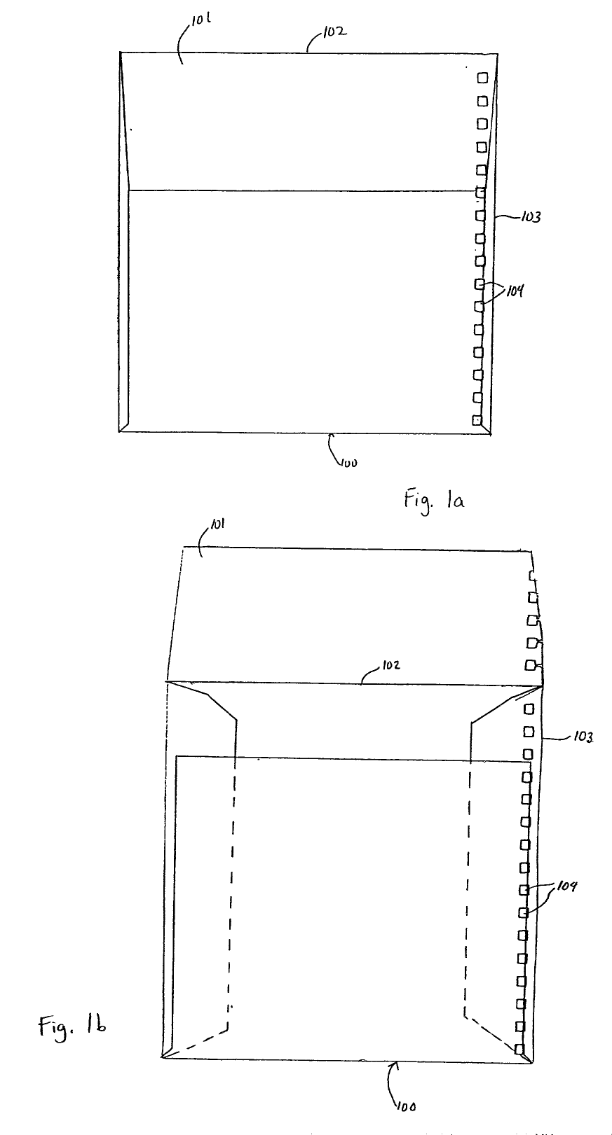

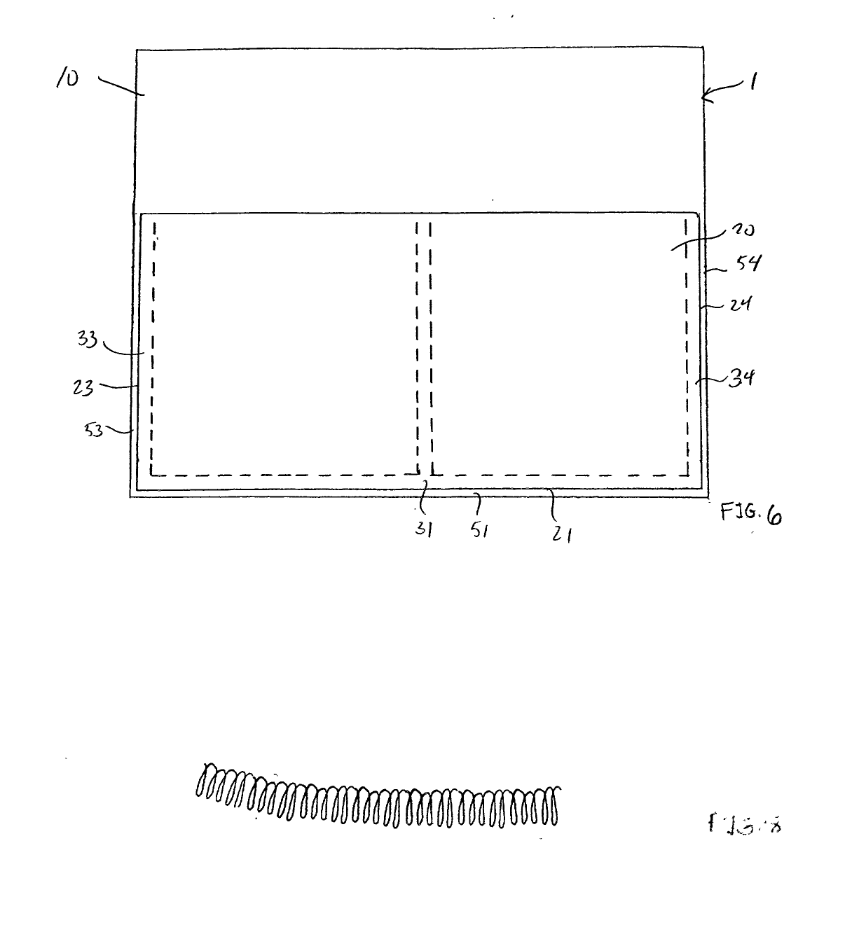

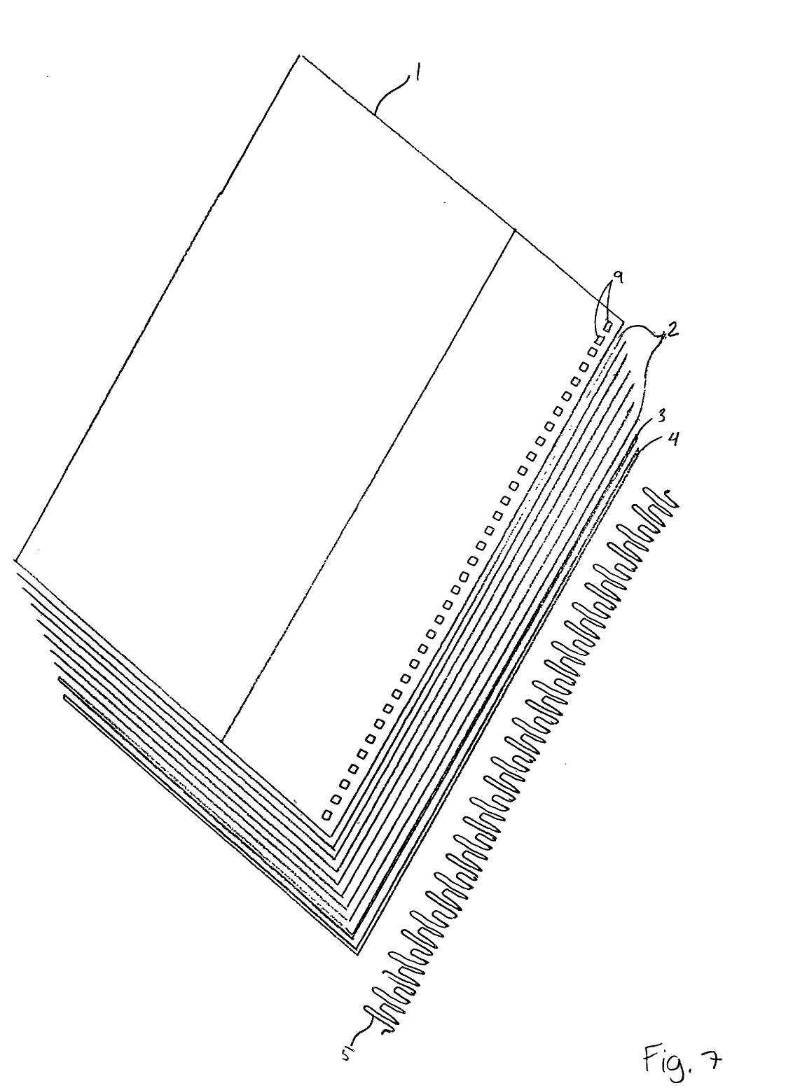

FIG. 7 illustrates a book including a pocket insert 1. The pocket insert 1 is assembled in a stacked arrangement with multiple pages 2; a front cover 3 and back cover 4 may also be included in the stacked arrangement. The materials may be stacked in the following order, from bottom to top: back cover, front cover, pages and pocket insert. More specifically, the pages can be received in a stacked arrangement from a printer or copier. Then, this stack of pages, along with the pocket insert and the covers, are placed in a binding machine that punch holes 9 in the various sheets of the stack and inserts a binder through the holes to connect the various sheet, such as a conventional spiral binder 5 (or wire-o binder 6, illustrated in FIG. 8). An operator can then insert a diskette, and/or other supplemental material, in the pocket of the pocket insert and turn the back cover along the binder so the book assumes its final orientation. This operation requires much less manual labor than the aforementioned method employing the sleeve of Figures 1a and 1b, reducing the binding operation time by up to 30 percent. Such time savings are significant when filling orders for large numbers of books.

A further advantage of the present invention is that the pocket insert may be automatically collated along with the pages. For example, the pages may be collated automatically as they are copied on a copier. Some copiers provide a supplemental tray to collate a supplement page along with the copied pages, i.e., a supplemental page onto which no information is being applied to the page. The pocket insert of this invention is suitable for such copying environments, thereby permitting the insert to be collated automatically with the various pages while the pages are being photocopied. For this embodiment, the pocket insert should be assembled of standard weight paper, and it is important that the insert is arranged in the collator tray such that edge 12 (this edge having a single-sheet thickness) is pushed by the copier roller during collation.

FIG. 6 illustrates a pocket insert 1 adapted for other binding operations. In some binding operations, the various pages are oversized, i.e., the pages include excess material around the perimeter of the pages; the oversized pages are first collated in a desired stacked arrangement and then excess material is trimmed from the perimeter of the stack with cutting knives. For example, the oversized pages may have the form of signature pages as referred to in the printing trade. The external dimensions of pocket insert 1 of FIG. 6 essentially match the external dimensions of the oversized pages. Excess material along regions 51, 53 and 54, as well as along the binding edge of the pocket insert, are trimmed along with the pages. The adhesive strips 31, 32 and 33 remain intact from the trimming operation to adhere the base sheet 10 and the pocket sheet 20 in the desired configuration. The stack containing the trimmed pages and pocket insert can then be bound along with desired front and back covers. For example, the trimmed pages and pocket insert can be assembled with front and back covers and bound with a spiral or wire-o binder through holes in the various sheets, as described previously, or the pages and insert can be bound to front and back covers with an adhesive as in conventional perfect bind operations.

While the invention has been described with reference to preferred embodiments, it will be understood by those skilled in the art that various changes may be made and equivalents may be substituted for elements thereof without departing from the scope of the invention. In addition, many modifications may be made to adapt a particular situation of material to the teachings of the invention without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed:

1. A book comprising multiple pages and a pocket insert bound along a binding, wherein the pocket insert comprises:
a base sheet of paper material comprising a binding edge bound to the binding; and
a pocket sheet of paper material, the perimeter of which is defined by an attached edge section and a free section, the attached edge section being attached to the base sheet and the free edge section being unattached to the base sheet to form a pocket with a pocket opening along the free edge section,
wherein the base and pocket sheets are arranged such that the pocket opening faces the binding.

2. The book of claim 1, wherein the pocket opening extends substantially parallel to the binding edge of the base sheet.

3. The book of claim 1, wherein the pocket sheet has a width smaller than a width of the base sheet but at least half the width of the base sheet.

4. The book of claim 3, wherein the pocket sheet has a width at least 60 percent of the width of the base sheet.

5. The book of claim 1, wherein the base sheet and the pocket sheet are formed of separate sheets of paper material that are adhered to one another along the attached edge section of the pocket sheet.

6. The book of claim 1, wherein the base sheet comprises:
a first edge,
a second edge opposed to the first edge and defining the binding edge, the first and second edges defining a width of the base sheet, and
third and fourth edges opposed to one another and disposed between the first and second edges, the third and fourth edges defining a length of the base sheet.

7. The book of claim 6, wherein the pocket sheet comprises:
a first edge attached to the base sheet,
a second edge opposed to the first edge, the first and second edges defining a width of the pocket sheet, at least a portion of the second edge being unattached to the base sheet for forming the pocket opening, and
third and fourth edges opposed to one another and disposed between the first and second edges, the third and fourth edges defining a length of the pocket sheet and being attached to the base sheet;
wherein the pocket sheet has a shorter width than the base sheet.

8. The book of claim 7, wherein the base sheet and the pocket sheet are adhered to one another along their respective first edges, third edges and fourth edges.

9. The book of claim 7, wherein the first edges of the base sheet and the pocket sheet are parallel to the second edges of the respective sheets, and the third edges of the base sheet and the pocket sheet are parallel to the fourth edges of the respective sheets.

10. The book of claim 9, wherein the base sheet and the pocket sheet are further adhered to one another along a strip parallel to the third and fourth edges of the sheets, so as to separate two pockets formed between the sheets.

11. The book of claim 7, wherein the base sheet and the pocket sheet are formed of a single section of paper material.

12. The book of claim 11, wherein the single section is folded along a fold line defining the first edges of the base sheet and the pocket sheet.

13. The pocket of claim 7, wherein the pocket sheet first edge is attached to the base sheet with an adhesive proximate to the base sheet first edge, the pocket sheet third edge is attached to the base sheet with an adhesive proximate to the base sheet third edge, and the pocket sheet fourth edge is attached to the base sheet with an adhesive proximate to the base sheet fourth edge.

14. The book of claim 13, wherein the pocket sheet is attached to the base sheet with an adhesive along a strip extending widthwise between the third and fourth edges of the sheets.

15. The book of claim 14, wherein the widthwise strip separates two pockets formed by the base sheet and the pocket sheet, both pockets opening towards the base sheet first edge.

16. The book of claim 1, wherein the base sheet is formed of a rectangular sheet of paper having a length of about 11 inches and a width of 8 to 8.5 inches.

17. The book of claim 16, wherein the pocket sheet is formed of a rectangular sheet of paper having a length of about 11 inches and a width of 5 to 6 inches.

18. The book of claim 17, wherein the multiple pages are rectangular sheets having a length of about 11 inches and a width of about 8.5 inches.

19. The book of claim 1, further comprising a front cover and a back cover bound along the binding, the pages and pocket insert being disposed between the front and back covers.

20. The book of claim 19, further comprising a diskette retained in the pocket.

21. The book of claim 15, further comprising diskettes retained in both pockets.

22. A pocket insert defined by a generally rectangular base sheet of paper material and a generally rectangular pocket sheet of paper material, the base sheet comprising:
a first edge, a second edge opposed to the first edge for binding to a binder, the first and second edges defining a width of the first sheet, and third and fourth edges opposed to one another and disposed between the first and second edges, the third and fourth edges defining a length of the first sheet;
the pocket sheet comprising:
a first edge attached to the base sheet, a second edge opposed to the first edge, the first and second edges defining a width of the pocket sheet, at least a portion of the second edge being unattached to the base sheet for forming a pocket opening, and third and fourth edges opposed to one another and disposed between the first and second edges, the third and fourth edges defining a length of the pocket sheet and being attached to the base sheet; wherein the second sheet has a shorter width than the first sheet and a width at least half the width of the base sheet.

23. The pocket insert of claim 22, wherein the base sheet and the pocket sheet are formed of separate sheets of paper material that are adhered to one another along their respective first edges, third edges and fourth edges.

24. The pocket insert of claim 23, wherein the base sheet and the pocket sheet are further adhered to one another along a strip parallel to the third and fourth edges of the sheets, so as to separate two pockets formed between the sheets.

25. The pocket insert of claim 22, wherein the base sheet is formed of a rectangular sheet of paper having a length of about 11 inches and a width of 8 to 8.5 inches, and the pocket sheet is formed of a rectangular sheet of paper having a length of about 11 inches and a width of 5 to 6 inches.

26. A method of binding a book comprising:
assembling in a stacked arrangement multiple pages and a pocket insert, wherein the pocket insert comprises:
a base sheet of paper material comprising a binding edge; and a pocket sheet of paper material, the perimeter of which is defined by an attached edge section and a free edge section, the attached edge section being attached to the base sheet and the free edge section being unattached to the base sheet to form a pocket with a pocket opening along the free edge section; and
binding the pages and the pocket insert, wherein the pocket insert is bound along its binding edge and the base and pocket sheets are arranged such that the pocket opens towards the binding.

27. The method of claim 26, comprising assembling a back and front cover in the stacked arrangement, and binding the covers, pages and pocket insert.

28. The method of claim 27, wherein the back and front covers are arranged adjacent one another in the stacked arrangement, and the pocket insert is arranged at the top of the stacked arrangement during binding.

29. The method of claim 28, further comprising inserting a diskette into the pocket insert following the binding operation.

30. The method of claim 29, wherein the pages and pocket insert are assembled in the stacked arrangement by an automated collator.

31. A method of making a series of books, each book including multiple pages, a pocket insert, and front and back covers bound along a common binding, comprising:
making multiple copies of individual pages by copying textual material on to the pages with a copier, and collating the copied pages in a collator of a copier to form stacked arrangements of copied pages for books in the series;
adding to each stacked arrangement a pocket insert, a front cover and a back cover; and binding the stacked arrangement with binders,
wherein the pocket insert comprises: a base sheet of paper material substantially corresponding in shape to the book pages and comprising a binding edge; and a pocket sheet of paper material, the perimeter of which is defined by an attached edge section attached to the base sheet and a free edge section unattached to the base sheet, to form a pocket with a pocket opening along the free edge section;
wherein the pocket insert is bound along its binding edge such that the pocket opens towards the binding.
